(19) United States
(12) Patent Application Publication
(10) Pub. No.: US 2008/0209054 A1
(43) Pub. Date: Aug. 28, 2008

(54) METHOD AND APPARATUS FOR RELAYING STREAMING DATA

(75) Inventors: Guanhua ZHANG, Suwon-si (KR); Sang-kwon Lee, Suwon-si (KR); Hyok-sung Choi, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/841,065

(22) Filed: Aug. 20, 2007

(30) Foreign Application Priority Data
Feb. 27, 2007 (KR) 10-2007-0019930

(51) Int. Cl. G06F 15/16

(52) U.S. Cl. 709/228

(57) ABSTRACT

Provided are a method and apparatus for relaying streaming data between peers including a first device and a second device in a peer-to-peer (P2P) overlay network. A method of relaying streaming data from the first device to the second device includes determining whether requested streaming data is streaming data that the first device is currently receiving when the first device is requested by the second device to relay streaming data to the second device. Then, the first device assigns a reception bandwidth for receiving the requested streaming data from a source device according to the determination result and receives the requested streaming data using the assigned reception bandwidth to relay the requested streaming data to the second device. Therefore, peers can receive streaming data at a high rate in a P2P network.

### CROSS-REFERENCE TO RELATED PATENT APPLICATION

This application claims the benefit of Korean Patent Application No. 10-2007-0019930, filed on Feb. 27, 2007, in the Korean Intellectual Property Office, the disclosure of which is incorporated herein in its entirety by reference.

### BACKGROUND OF THE INVENTION

1. Field of the Invention

Apparatuses and methods consistent with the present invention relate to relaying streaming data, and in particular, to a method and apparatus for relaying streaming data between peers in a peer-to-peer (P2P) overlay network.

2. Description of the Related Art

FIG. 1 is a diagram illustrating a conventional peer-to-peer (P2P) network.

Unlike a conventional server-client based network, a P2P network contains peers having equivalent qualifications for sharing distributed resources. Since a server is required to provide services to all clients in a conventional client-server based network, bottlenecks occur in such a network, thereby causing a problem of not guaranteeing enough quality of service (QoS).

However, in a P2P network, all peers share network and/or hardware resources and provide two-way services, thereby overcoming the above-described problem in conventional client-server based networks.

FIG. 1 is a diagram illustrating a conventional P2P network structure including three separate P2P networks. Referring to FIG. 1, each of the P2P networks includes a channel through which data is provided to peers in the P2P network. Eight peers P1 through P8 receive data from a source device S1 through a channel 1, five peers P9 through P13 receive data from a source device S2 through a channel 2, and two peers P14 and P15 receive data from a source device S3 through a channel 3.

In each channel, each peer shares network resources with other peers by providing received data to other peers. In the conventional P2P network structure illustrated in FIG. 1, the source devices S1, S2 and S3 transmit data to peers, and the peers P1 through P15 transmit data received from the source devices S1, S2, and S3 to other peers, so that data can be transmitted and received efficiently in the P2P network.

Referring to FIG. 1, peers receiving data from the source devices S1, S2 and S3 constitute respective P2P overlay networks in the conventional P2P network structure. The peers P1 through P8 are interested in data of the source device S1 only, and the peers P9 through P13 are interested in data of the source device S2 only.

In the conventional P2P network structure illustrated in FIG. 1, the channel 1 connects more peers than the channel 3. Thus, the peers connected by the channel 1 can receive data of the source device S1 from relatively many peers, while the peers connected by the channel 3 receive data of the source device S3 from relatively fewer peers. That is, the peers connected by the channel 1 can receive data more quickly than those connected by the channel 3.

If data provided by the source devices S1 through S3 is real-time streaming data that should be received and played in real time, the difference in receiving speed represents the difference in the quality of service.

Since the channel 1 connects many peers, a peer connected to the channel 1 can receive data of the source device S1 from many peers relaying the data, such that the peer can receive the data at a high rate.

However, since fewer peers are connected by the channel 3 than those connected by the channel 1, a peer connected to the channel 3 receives data of the source device S3 from fewer peers relaying the data, such that the peer cannot receive the data at a high rate.

### SUMMARY OF THE INVENTION

The present invention provides a method and apparatus for efficiently sharing network resources and relaying streaming data between peers in a peer-to-peer (P2P) overlay network to ensure reliable quality of service (QoS) for streaming data. The present invention also provides a computer-readable recording medium having a computer-readable program for executing the method.

According to an aspect of the present invention, there is provided a method of relaying streaming data from a first device to a second device, the method including the operations of: when the first device is requested by the second device to relay streaming data to the second device, determining whether the requested streaming data is streaming data that the first device is currently receiving; assigning a reception bandwidth for receiving the requested streaming data from a source device according to the determination result; and receiving the requested streaming data using the assigned reception bandwidth so as to relay the requested streaming data to the second device.

The operation of assigning the reception bandwidth may include the sub-operations of: if the requested streaming data is not the streaming data that the first device is currently receiving, determining whether there is a spare bandwidth that is currently not used by the first device for receiving streaming data; and assigning at least a portion of the spare bandwidth for receiving the requested streaming data according to the determination result.

The operation of receiving the streaming data may include the sub-operations of: receiving the requested streaming data from the source device using the assigned spare bandwidth; buffering the received streaming data; and transmitting the buffered streaming data to the second device.

The operation of transmitting the buffered streaming data may include the sub-operations of: assigning a transmission bandwidth for transmitting the buffered streaming data to the second device; and transmitting the buffered streaming data to the second device using the assigned transmission bandwidth.

According to another aspect of the present invention, there is provided an apparatus for a first device to relay streaming data to a second device, the apparatus including: a controller which determines whether requested streaming data is streaming data that the first device is currently receiving when the second device requests the first device to relay streaming data; an assignment unit which assigns a reception bandwidth for receiving the requested streaming data from a source device according to the determination result; and a relay unit which receives the requested streaming data using the assigned reception bandwidth so as to relay the requested streaming data to the second device.

The assignment unit may include: a decision unit which determines whether there is a spare bandwidth that is currently not used by the first device for receiving streaming data if the requested streaming data is not the streaming data that the first device is currently receiving; and an assignment unit which assigns at least a portion of the spare bandwidth for receiving the requested streaming data according to the determination result.

According to another aspect of the present invention, there is provided a method for a first device to receive streaming data from a second device, the method including the operations of: requesting the second device to relay streaming data; and receiving the streaming data that is relayed from a source device through the second device after the second device determines whether the requested streaming data is streaming data that the second device is currently receiving and assigns a reception bandwidth for receiving the requested streaming data from the source device according to the determination result.

According to another aspect of the present invention, there is provided an apparatus for a first device to receive streaming data from a second device, the apparatus including a reception unit which receives the streaming data that is relayed from a source device through the second device after the second device determines whether the requested streaming data is streaming data that the second device is currently receiving and assigns a reception bandwidth for receiving the requested streaming data from the source device according to the determination result.

The first and second devices are peers included in a peer-to-peer (P2P) overlay network.

According to another aspect of the present invention, there is provided a computer-readable recording medium having a computer-readable program for executing the method of relaying or receiving the requested streaming data.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram illustrating a conventional peer-to-peer (P2P) network structure;

FIG. 2 is a diagram illustrating a P2P network structure according to an exemplary embodiment of the present invention;

FIG. 3 is a diagram for explaining a method of relaying streaming data according to an exemplary embodiment of the present invention;

FIG. 4 is a flowchart illustrating a method of assigning a bandwidth for receiving streaming data according to an exemplary embodiment of the present invention;

FIG. 5 is a diagram illustrating a data packet for transmitting streaming data according to an exemplary embodiment of the present invention;

FIG. 6 is a diagram illustrating a relay apparatus for relaying streaming data according to an exemplary embodiment of the present invention; and

FIG. 7 is a diagram illustrating a reception apparatus for receiving streaming data according to an exemplary embodiment of the present invention.

### DETAILED DESCRIPTION OF EXEMPLARY EMBODIMENTS OF THE INVENTION

Exemplary embodiments of the present invention will be more fully described with reference to the appended drawings.

FIG. 2 is a diagram illustrating a peer-to-peer (P2P) network structure according to an embodiment of the present invention.

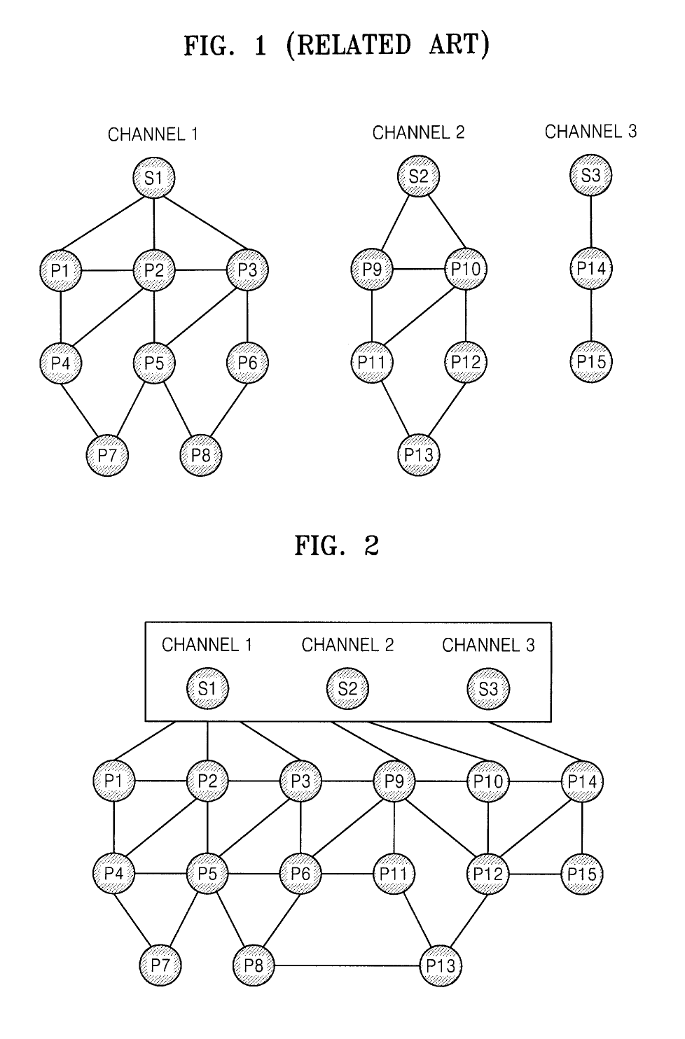

Referring to FIG. 2, peers receiving different data are included in an overlay network. In a conventional P2P network structure as illustrated in FIG. 1, peers are included in separate networks according to channels (that is, according to data provided by source devices). However, in the P2P network structure according to the current embodiment of the present invention, each P2P network is connected to other P2P networks to form a single P2P network.

Referring to FIG. 2, peers P1 through P8 receiving data from a source device S1, peers P9 through P13 receiving data from a source device S2, and peers P14 to P15 receiving data from a source device S3 are connected to each other to form a single P2P network.

For example, when the peer P9 receives data from the source device S2, the peer P9 can also receive the data of the source device S2 via the peer P3 as shown in FIG. 2. Likewise, when the peer P14 receives data from the source device S3, the peer P14 can also receive the data of the source device S3 via the peer P10.

In the conventional P2P network structure illustrated in FIG. 1, the peer P14 could receive data only from the source device S3 or the peer P15. However, in the P2P network structure according to the current embodiment of the present invention, the peer P14 can receive data of the source device S3 from at least one of the peer P10 and the peer P12 that are interested in data of the source device S2 as well as the source device S3 and the peer P15.

In the P2P network structure of FIG. 2, the three source devices S1 through S3 may provide different data to each other. However, it can be easily understood by those of ordinary skill in the art that the present invention can be applied to any case where a plurality of source devices exist in a P2P overlay network.

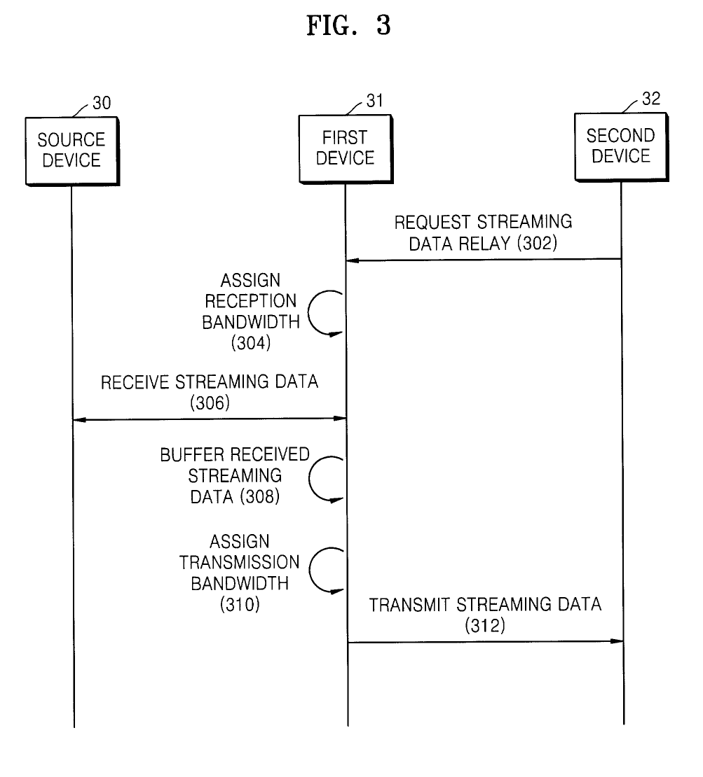

In order to overcome problems associated with a conventional P2P network, the P2P network structure according to the current embodiment of the present invention is designed such that peers assign their network resources for relaying data to other peers as well as for receiving their own data. A method for a peer to assign a bandwidth to data to be relayed to other peers will now be described with reference to FIGS. 3 through 5.

FIG. 3 is a diagram for explaining a method of relaying streaming data according to an embodiment of the present invention.

Referring to FIG. 3, a source device 30, a first device 31, and a second device 32 are included in a P2P network. The first device 31 and the second device 32 are peers in the P2P network. The first device 31 receives streaming data, bound for the second device 32, from the source device 30, and relays the streaming data to the second device 32.

In operation 302, the second device 32 requests the first device 31 to relay the streaming data.

The second device 32 can directly receive streaming data from the source device 30. However, the second device 32 can also receive the streaming data of the source device 30 indirectly from the first device 31 by requesting the first device 31 to relay the streaming data. For this, the second device 32 can use network resources of the first device 31 for receiving the streaming data of the source device 30.

If the second device 32 requests a relay, the first device 31 will check its own bandwidth and assign a proper network bandwidth to the streaming data to be relayed. When requesting the relay of the streaming data, the second device 32 may request the first device 31 to assign a predetermined sized bandwidth to the requested streaming data. Here, the network bandwidth used in the relay includes a reception bandwidth through which the first device 31 receives streaming data from the source device 30 and a transmission bandwidth through which the first device 31 transmits the received streaming data to the second device 32.

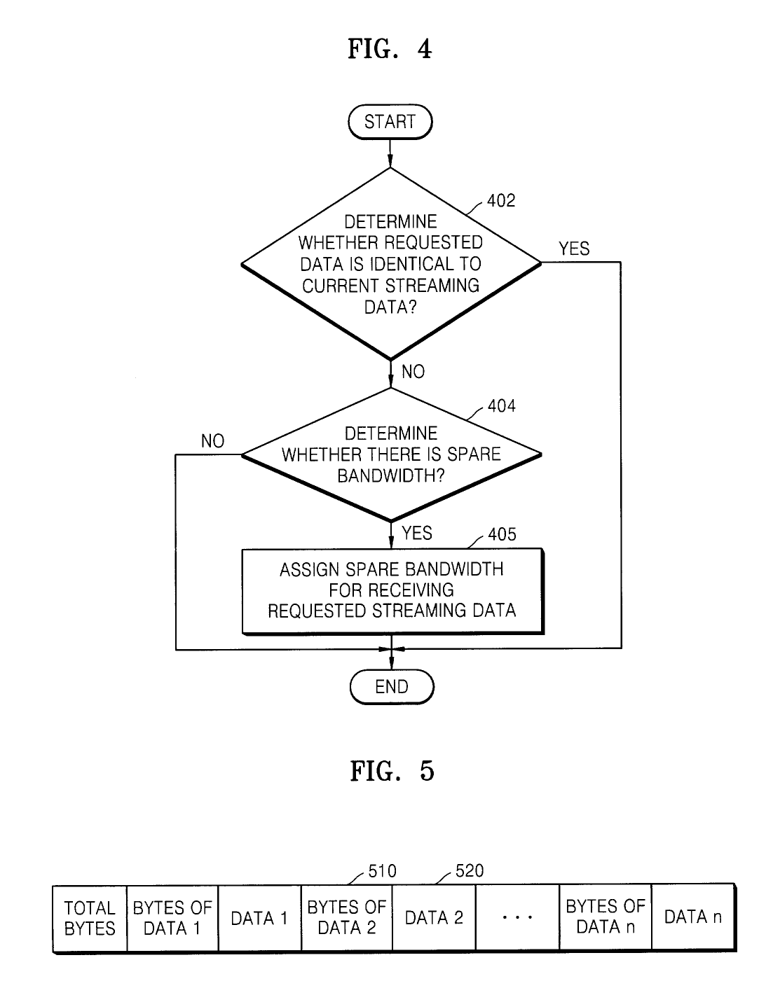

In operation 304, the first device 31 assigns a reception bandwidth for receiving the streaming data from the source device 30 that is to be relayed to the second device 32. Operation 304 will now be more fully described with reference to FIG. 4.

FIG. 4 is a flowchart illustrating a method of assigning a reception bandwidth for receiving streaming data according to an embodiment of the present invention.

Referring to FIG. 4, in operation 402, the first device 31 determines whether the streaming data requested from the second device 32 in operation 302 is the streaming data that the first device 31 is currently receiving.

If the streaming data requested from the second device 32 is the streaming data that the first device 31 is currently receiving for playback, the first device 31 does not have to assign a separate reception bandwidth for receiving the streaming data since the first device 31 is already receiving the streaming data using a predetermined bandwidth. That is, in this case, the streaming data that the first device 31 is currently receiving is transmitted to the second device 32.

In operations 404 to 405, the first device 31 discriminately assigns a reception bandwidth for receiving the streaming data requested by the second device 32 according to the determination result in operation 402.

If the streaming data requested from the second device 32 is not the streaming data that the first device 31 is currently receiving for playback, the first device 31 determines whether there is a spare network resource (i.e., a spare bandwidth) that can be assigned for the streaming data requested from the second device 32 in operation 404.

The first device 31 checks the QoS of streaming data which is currently being received and played and determines whether there is a spare bandwidth that can be assigned for receiving the streaming data requested by the second device 32 without affecting the QoS of the currently received streaming data. As a method of checking the QoS of the currently-received streaming data, the first device 31 checks whether the currently-received streaming data is continuously being played without a break or delay.

The first device 31 assigns a bandwidth for receiving its streaming data and then assigns a remaining bandwidth (spare bandwidth) for receiving the streaming data requested by the second device 32. In detail, the remaining bandwidth except the bandwidth used by the first device 31 for receiving and playing the current streaming data is used for receiving the streaming data requested by the second device 32. Since the remaining bandwidth not used for the first device 31 to receive and play the current streaming data is used for receiving streaming data from the source device 30 for relaying the streaming data to other peers in a P2P network, all peers in the P2P network can receive streaming data at a high rate.

If it is determined that there is no spare bandwidth in operation 404, the procedure ends without assigning a separate bandwidth for receiving streaming data to be relayed. Alternatively, a minimal bandwidth can be assigned for receiving streaming data to be relayed even though there is no spare bandwidth.

If it is determined that there is spare bandwidth, the first device 31 assigns the spare bandwidth for receiving the request streaming data in operation 405.

In detail, if it is determined that there is a remaining bandwidth which does not affect the QoS of the current streaming data in operation 404, the first device 31 assigns the spare bandwidth for receiving the streaming data requested by the second device 32 to relay the streaming data to the second device 32.

In operation 306, the first device 31 receives the streaming data, requested by the second device 32, from the source device 30.

If the requested streaming data is the same data as the first device 31 is currently receiving and playing, the first device 31 transmits the streaming data to the second device 32 directly.

However, if the requested streaming data is not the same data as the first device 31 is currently receiving and playing, the first device 31 requests the source device 30 to transmit the streaming data requested by the second device 32 and receives the streaming data from the source device 30 using the reception bandwidth assigned in operation 304.

In operation 308, the first device 31 temporarily stores the streaming data received from the source device 30.

The first device 31 does not directly transmit the streaming data received from the source device 30 to the second device 32, but transmits the streaming data after temporarily storing the streaming data. Due to this buffering process, the streaming data can be stably relayed from the source device 30 to the second device 32 through the first device 31.

The buffering process also can minimize a delay occurring when the first device 31 changes a channel. When the first device 31 changes the current channel to end the playback of the current streaming data and play other streaming data, a delay can occur due to the channel change. However, according to the current embodiment of the present invention, streaming data that the first device 31 is going to play can be identical to data buffered in the first device 31 for relaying the streaming data to another device. In this case, the first device 31 can directly play the buffered data without changing a channel to receive the streaming data. Thus, a channel change delay can be reduced.

In operation 310, the first device 31 assigns a transmission bandwidth to the streaming data buffered in operation 308 to transmit the streaming data to the second device 32.

Since the first and second devices 31 and 32 are peers included in the P2P network, the first and second devices 31 and 32 relay all streaming data to other peers in the P2P network. Therefore, streaming data relayed from the first device 31 to the second device 32 may include streaming data destined for other peers as well as streaming data destined for the second device 32. This will now be described in detail with reference to FIG. 5.

FIG. 5 is a diagram illustrating a data packet for transmitting streaming data according to an embodiment of the present invention.

Referring to FIG. 5, the payload of a data packet that the first device 31 transmits to the second device 32 includes data received from a plurality of source devices. The P2P network according to the present invention includes a plurality of source devices as described with reference to FIG. 2. Therefore, peers relay different data in the P2P network. Thus, the data packet transmitted by the first device 31 to the second device 32 includes a plurality of different data sections as illustrated in FIG. 5.

When the second device 32 requests the first device 31 to relay streaming data of a specific source device (e.g., the source device 30), the first device 31 receives the requested streaming data from the source device 30. The first device 31 assigns a predetermined section of the data packet to the received streaming data. In this way, the first device 31 can assign a transmission bandwidth to the streaming data for transmitting the streaming data to the second device 32.

If the second device 32 requests the first device 31 to relay data 2 of the source device S2 (refer to FIG. 2), the first device 31 performs a transmission bandwidth assignment for transmitting streaming data by assigning a section 520 of the data packet to the data 2.

The first device 31 can adjust the transmission bandwidth by increasing or decreasing the section 520 of the data packet assigned to the data 2.

An example will now be explained as follows, in which the first device 31 transmits the data 2 to the second device 32 in response to a relay request from the second device 32. When the first device 31 finishes playing the current streaming data, more bandwidth can be used to receive streaming data that will be relayed to the second device 32. In this case, the first device 31 can receive streaming data from the source device 30 using a larger bandwidth for relaying the streaming data to the second device 32. Furthermore, the first device 31 can increase a transmission bandwidth for transmitting the received streaming data to the second device 32. For example, the first device 31 can increase the length of the section 520 of the data packet to increase the transmission bandwidth.

On the contrary, when the first device 31 should assign more bandwidth to the current streaming data due to a deterioration of the QoS of the current streaming data, the first device 31 may decrease the bandwidth assigned for receiving streaming data to be relayed to the second device 32. In this case, the first device can decrease the bandwidth by shortening the length of the section 520 of the data packet assigned for receiving streaming data to be relayed to the second device 32.

Referring again to FIG. 3, in operation 312, the first device 31 transmits the streaming data buffered in operation 308 to the second device 32 using the transmission bandwidth assigned in operation 310. If a predetermined section of a data packet, to be transmitted from the first device 31 to the second device 32, is assigned to the buffered streaming data in operation 310, the first device 31 inserts the buffered streaming data into the predetermined section of the data packet and transmits the data packet to the second device 32.

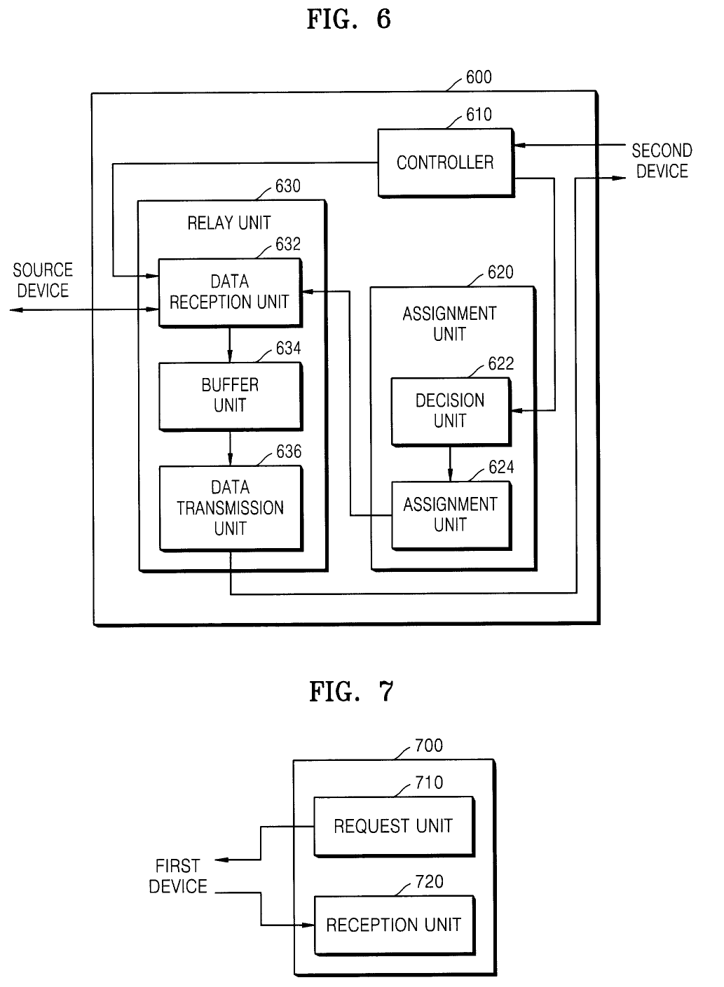

FIG. 6 is a diagram illustrating a relay apparatus 600 for relaying streaming data according to an embodiment of the present invention.

Referring to FIG. 6, the relay apparatus 600 may be included in the first device 31. The relay apparatus 600 includes a controller 610, an assignment unit 620, and a relay unit 630.

The controller 610 receives a streaming data relay request from the second device 32 and determines whether requested streaming data is identical to streaming data which the first device 31 is currently receiving.

When the second device 32 requests the first device 31 to relay the streaming data, the second device 32 can specify a desired bandwidth size for relaying the streaming data.

If the requested streaming data is identical to the streaming data currently being received and played by the first device 31, the controller 610 signals the relay unit 630 to transmit the streaming data currently being received and played by the first device 31, to the second device 32.

However, if the requested streaming data is not identical to the streaming data currently being received and played by the first device 31, the controller 610 controls the assignment unit 620 to assign a bandwidth for receiving and transmitting the requested streaming data.

The assignment unit 620 assigns a relay bandwidth for relaying streaming data in a discriminate manner according to the control of the controller 610. The assignment unit 620 of the current embodiment includes a decision unit 622 and an assignment unit 624.

When the streaming data requested from the second device 32 through the controller 610 is different from the streaming data that the first device 31 is currently receiving and playing, the decision unit 622 determines whether there exists a spare bandwidth to be assigned for receiving the requested streaming data. In detail, the decision unit 622 checks the QoS of the steaming data that the first device 31 is currently receiving and playing to determine whether there is a spare bandwidth that can be used for receiving the requested streaming data without affecting the QoS of the current streaming data.

The assignment unit 624 assigns the spare bandwidth determined by the decision unit 622 to the requested streaming data. The assignment unit 624 performs the bandwidth assignment by allocating a section of a data packet (refer to the data packet of FIG. 5 destined from the first device 31 to the second device 32) for receiving the requested streaming data. The relay unit 630 relays the requested streaming data using the assigned bandwidth.

The relay unit 630 relays the requested streaming data from the source device 30 to the second device 32 under the control of the controller 610 and the assignment unit 620. The relay unit 630 of the current embodiment includes a data reception unit 632, a buffer unit 634 and a data transmission unit 636.

The data reception unit 632 receives the streaming data to be relayed to the second device 32 from the source device 30. If the controller 610 determines that the streaming data requested by the second device 32 is identical to streaming data currently being received and played by the first device 31, the data reception unit 632 relays the currently receiving streaming data to the second device 32 via the buffer unit 634 and the data transmission unit 636.

However, if the requested streaming data is determined to be different from the currently playing streaming data, the data reception unit 632 requests the source device 30 to transmit the streaming data and receives the streaming data using the assigned bandwidth.

The buffer unit 634 buffers the streaming data received by the data reception unit 632 from the source device 30. The buffer unit 634 buffers the received streaming data instead of transmitting the streaming data instantly, so that the buffer unit 634 can increase the stability of the data transmission and minimize a delay caused by a channel change.

The data transmission unit 636 transmits the streaming data buffered in the buffer unit 634 to the second device 32. The data transmission unit 636 assigns a transmission bandwidth for transmitting the streaming data to the second device 32 by assigning a section of a data packet destined for the second device 32 to the streaming data received in the data reception unit 632. The data transmission unit 636 inserts the streaming data into the data packet destined for the second device 32 and transmits the data packet to the second device 32.

FIG. 7 is a diagram illustrating a reception apparatus 700 for receiving streaming data according to an embodiment of the present invention.

Referring to FIG. 7, the reception apparatus 700 may be included in the second device 32 for receiving streaming data. The reception apparatus 700 includes a request unit 710 and a reception unit 720.

The request unit 710 requests the first device 31 to relay streaming data. The request unit 710 can request the first device 31 to relay streaming data using a specific bandwidth.

The reception unit 720 receives the streaming data transmitted by the first device 31 in response to the request of the request unit 710. The reception unit 720 determines whether the streaming data requested by the request unit 710 is identical to streaming data that the first device 31 is currently receiving and playing. Then, according to the determination result, the reception unit 720 receives the streaming data from the first device 31 according to bandwidths assigned for receiving the requested streaming data and transmitting the streaming data.

According to the present invention, network resources can be more efficiently shared by peers in a P2P network so that the peers can receive streaming data at a high rate.

Furthermore, each peer relays streaming data after buffering the streaming data, so that a delay caused by a channel change can be minimized and streaming data can be stably relayed.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention. The invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code can be stored and executed in a distributed fashion.

What is claimed is:

1. A method of relaying streaming data from a first device to a second device, the method comprising:
when the first device is requested by the second device to relay streaming data to the second device, determining whether the requested streaming data is streaming data that the first device is currently receiving;
assigning a reception bandwidth for receiving the requested streaming data from a source device according to the determination result; and
receiving the requested streaming data using the assigned reception bandwidth so as to relay the requested streaming data to the second device.

2. The method of claim 1, wherein the first and second devices are peers included in a peer-to-peer (P2P) overlay network.

3. The method of claim 1, wherein the assigning of the reception bandwidth comprises:
if the requested streaming data is not the streaming data that the first device is currently receiving, determining whether there is a spare bandwidth that is currently not used by the first device for receiving streaming data; and
assigning at least a portion of the spare bandwidth for receiving the requested streaming data according to the determination result.

4. The method of claim 3, wherein the receiving of the streaming data comprises:
receiving the requested streaming data from the source device using the assigned spare bandwidth;
buffering the received streaming data; and
transmitting the buffered streaming data to the second device.

5. The method of claim 4, wherein the transmitting of the buffered streaming data comprises:
assigning a transmission bandwidth for transmitting the buffered streaming data to the second device; and
transmitting the buffered streaming data to the second device using the assigned transmission bandwidth.

6. The method of claim 5, wherein the assigning of the transmission bandwidth comprises assigning a section of a data packet to be transmitted by the first device to the second device, to the requested streaming data.

7. An apparatus for a first device to relay streaming data to a second device, the apparatus comprising:
a controller which determines whether requested streaming data is streaming data that the first device is currently receiving when the second device requests the first device to relay streaming data;
an assignment unit which assigns a reception bandwidth for receiving the requested streaming data from a source device according to the determination result; and
a relay unit which receives the requested streaming data using the assigned reception bandwidth so as to relay the requested streaming data to the second device.

8. The apparatus of claim 7, wherein the first and second devices are peers included in a P2P overlay network.

9. The apparatus of claim 7, wherein the assignment unit comprises:
a decision unit which determines whether there is a spare bandwidth that is currently not used by the first device for receiving streaming data if the requested streaming data is not the streaming data that the first device is currently receiving; and
an assignment unit which assigns at least a portion of the spare bandwidth for receiving the requested streaming data according to the determination result.

10. The apparatus of claim 9, wherein the relay unit comprises:
a data reception unit which receives the requested streaming data from the source device using the assigned spare bandwidth;
a buffer unit which buffers the received streaming data; and
a data transmission unit which transmits the buffered streaming data to the second device.

11. The apparatus of claim 10, wherein the data transmission unit assigns a transmission bandwidth for transmitting the buffered streaming data to the second device and transmits the buffered streaming data to the second device using the assigned transmission bandwidth.

12. The apparatus of claim 11, wherein the data transmission unit assigns a section of a data packet to be transmitted by the first device to the second device, to the requested streaming data.

13. A method for a first device to receive streaming data from a second device, the method comprising:
requesting the second device to relay streaming data; and
receiving the streaming data that is relayed from a source device through the second device after the second device determines whether the requested streaming data is streaming data that the second device is currently receiving and assigns a reception bandwidth for receiving the requested streaming data from the source device according to the determination result.

14. The method of claim 13, wherein the first and second devices are peers included in a P2P overlay network.

15. The method of claim 13, wherein the receiving of the streaming data comprises receiving streaming data included in a data packet transmitted from the second device, the data packet comprising a section assigned for the streaming data.

16. An apparatus for a first device to receive streaming data from a second device, the apparatus comprising:
a request unit which requests the second device to relay streaming data; and
a reception unit which receives the streaming data that is relayed from a source device through the second device after the second device determines whether the requested streaming data is streaming data that the second device is currently receiving and assigns a reception bandwidth for receiving the requested streaming data from the source device according to the determination result.

17. The apparatus of claim 16, wherein the first and second devices are peers included in a P2P overlay network.

18. The apparatus of claim 16, wherein the reception unit receives the receiving streaming data that is included in a data packet transmitted from the second device, the data packet comprising a section assigned for the streaming data.

19. A computer-readable recording medium having a computer-readable program for executing the method of claim 1.

20. A computer-readable recording medium having a computer-readable program for executing the method of claim 13.
